(19) United States
(12) Patent Application Publication
(10) Pub. No.: US 2023/0198445 A1
(43) Pub. Date: Jun. 22, 2023

(54) N-PHASE ELECTRIC MACHINE WITH CONFIGURABLE WINDINGS

(71) Applicant: Exro Technologies Inc., Calgary (CA)

(72) Inventor: Eric HUSTEDT, Calgary (US)

(21) Appl. No.: 18/066,375

(22) Filed: Dec. 15, 2022

Related U.S. Application Data
(60) Provisional application No. 63/290,741, filed on Dec. 17, 2021.

(51) Int. Cl. H02P 25/18

(52) U.S. Cl. CPC H02P 25/188

(57) ABSTRACT

A system for connecting individual coils of an electric machine. A plurality of coils each having a first connection node and a second connection node is provided in each of a plurality of stator slots and the plurality of coils are electrically connected as coil packs. For an N-phase electric machine there are 2N coil packs. The first connection node and the second connection node for each coil are accessible to implement a plurality of electric machine configurations.

### CROSS REFERENCE TO RELATED APPLICATION

The present application for patent claims the benefit of U.S. Provisional Application No. 63/290,741 filed Dec. 17, 2021, and expressly incorporated by reference herein.

### TECHNICAL FIELD

The present disclosure generally relates to an n-phase electric machine having individually accessible coils that can be connected in different winding configurations.

### BACKGROUND

### Description of the Related Art

Known power electronics systems deliver current to electric machine coils using three phase inverters. Three phase inverters lack the ability to switch between winding configurations, such as a series winding configuration and a parallel winding configurations. Further, using an inverter, there is no ability to enable different connection configurations of the electric machine such as AC charging, PV MPPT (Maximum Power Point Tracking), and the like. MPPT is a controller algorithm used for extracting maximum available power from a PV module under certain conditions.

Further, known electric machines do not provide access to each coil. Therefore, the electrical connection of the electric machine cannot be dynamically modified.

### BRIEF SUMMARY

The disclosed n-phase electric machine is paired with coil driver, which is a power electronics system that delivers current to motor coils. The n-phase electric machine can be switched between series winding configurations, parallel winding configurations, and a combination of parallel and series winding configurations because each coil of the electric machine is individually connected. The ability to provide different ways in which the electric machine is connected, which enables other functions, such as AC charging, PV MPPT, and the like.

One aspect of the invention is an N-phase electric machine that comprises a rotor, a stator having a plurality of stator slots and a coil for each stator slot, and a plurality of coil packs, each coil pack comprising at least two coils, wherein for the N-phase electric machine there are 2N coil packs, and first and second nodes, typically configured as an electrical input and an electrical output for each coil, wherein the respective first and second nodes are dynamically connectable to implement an electric machine configuration. For example, for a 3-phase electric machine there are six (6) coil packs comprising at least six (6) coils, two (2) coils packs per phase. The (2) coils packs per phase require at least four (4) wire connections, more wire connections may be necessary if there are more coils per coil pack.

According to one aspect of the invention, the 2N coil packs for every N phases are electrically isolated.

According to one aspect of the invention, the electric machine configuration comprises at least one of a delta configuration and a wye configuration.

According to one aspect of the invention, each coil pack comprises at least one of series coils and parallel coils.

According to one aspect of the invention, the N-phase electric machine includes a connector block comprising a connection for each input and each output of each coil. Preferably, the connector block is accessible from an outside of the electric machine.

One aspect of the invention is a system comprising:

an N-phase electric machine comprising:
a rotor;
a plurality of coils;
a stator having a plurality of stator slots and a respective one of the plurality of coils arranged in each stator slot;
a plurality of coil packs, each coil pack comprising at least two coils of the plurality of coils, wherein for the N-phase electric machine there are 2N coil packs; and
an electrical input and an electrical output for each coil;

a connection block having a respective connection point for each of the electrical inputs and each of the electrical outputs for each coil; and

a coil driver that dynamically configures the respective coils of the coil packs and provides a driving current to the coils via the connection block so that the respective coils in each coil pack are connected in series winding configurations, parallel winding configurations, and a combination of parallel and series winding configurations.

The coil driver is able to switch between series winding configurations and parallel winding configurations or a combination thereof because it has access to each coil in each isolated coil packs requiring multiple wire connections per phase. In other words, the electric machine has 2N electrically isolated coil packs for every N phases. The 2N coil packs of the electric machine can be connected in series or parallel depending on torque and/or speed requirements.

Each coil pack is separately connected so that the electric machine is configurable. The electric machine is connected to a coil driver or an inverter by a connector block. The connector block is arranged between the electric machine and the coil driver or inverter. The connectability of the coils in each coil pack in different configurations is enabled by the connector block arranged between the electric machine and the coil driver or inverter. Because each coil can be accessed individually, the electrical connection of the electric machine can be dynamically modified.

The coil packs of the electric machine do not have a native star or delta configuration because the coil packs are electrically configured by the connection to the coil driver via the connector block.

The coil driver connects to a given electric machine such that the inverter can manage a voltage across each individual coil pack.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a coil driver, connection block, and electric machine, according to at least one illustrated implementation.

FIG. 2A is a schematic diagram of a set of coils of each phase of a three phase electric machine in a delta configuration.

FIG. 2B is a schematic diagram of a set of coils of each phase of a three phase electric machine in a wye configuration.

FIG. 3 is a schematic diagram of a single phase coil driver circuit, according to at least one illustrated implementation.

FIG. 4 is a schematic diagram showing a 48 slot, three-phase electric machine with windings or coils electrically coupled XYW, according to at least one illustrated implementation.

FIG. 5 is a schematic diagram showing a 48 slot, three-phase electric machine with windings or coils electrically coupled XYX, according to at least one illustrated implementation.

FIG. 6 is a schematic diagram showing a 48 slot, three-phase electric machine with windings or coils electrically coupled XYZ, according to at least one illustrated implementation.

FIG. 7 is a schematic diagram of a coil pack.

FIG. 8 is an schematic diagram of an equivalent electrical circuit for the coil pack of FIG. 7.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

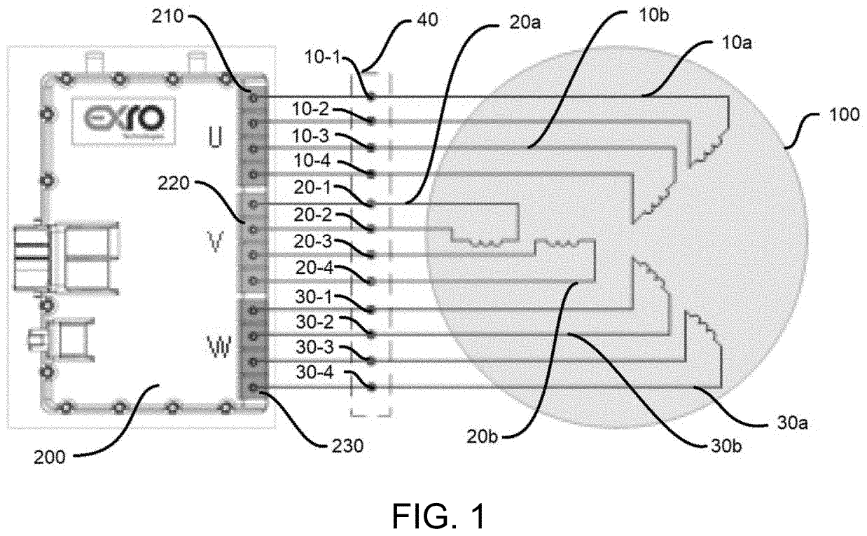

FIG. 1 is a schematic of a coil driver 200, connection block 40, and an N-phase electric machine 100. Electric machine 100 is a three-phase device having six coils 10a, 10b, 20a, 20b, 30a, and 30b, two coils per phase. A first phase comprises coils 10a, 10b, a second phase comprises coils 20a, 20b, and a third phase comprises coils 30a, 30b. While disclosed with respect to a three-phase electric machine other electric machines are contemplated within the scope of this disclosure as the disclosed configuration is scalable. While the coils 10a, 10b, 20a, 20b, 30a, and 30b for the three-phase machine are shown as 6 simple coils, this is a schematic representation as each coil can be made up of multiple series and/or parallel connected coils in the stator slots. The coil driver 200 is a power electronics system that delivers current to electric machine coils 10a, 10b, 20a, 20b, 30a, and 30b. Coil driver 200 can connect the electric machine coils so that they can be connected in series or parallel. The coil driver 200 accesses the two isolated coil per phase, which requires four (4) wire connections per phase. The coil driver 200 has a first connection block 210 for the first phase of the electric machine that has four isolated connections, a second connection block 220 for the second phase of the electric machine that has four isolated connections, a third connection block 230 for the third phase of the electric machine that has four isolated connections.

The connection block 40 is arranged electrically between the coil driver 200 and the electric machine 100. The connection block 40 has three sets of connections, one for each phase of the electric machine 100. According to one aspect of the invention, the connection block is part of the electric machine 100. The coils 10a, 10b of the first phase are connected to the first connection block 210 of the coil driver 200 via connections 10-1, 10-2, 10-3, and 10-4. Preferably, the connection block 210 has a respective connection pair for each coil of the electric machine. The coils 20a, 20b of the second phase are connected to the second connection block 220 of the coil driver 200 via connections 20-1, 20-2, 20-3, and 20-4. The coils 30a, 30b of the third phase are connected to the third connection block 230 of the coil driver 200 via connections 30-1, 30-2, 30-3, and 30-4.

As shown, in FIG. 1 there are two coils for every phase of the electric machine. It should be noted that the two coils for every phase can be made up from multiple individual coils. Other configurations are conceivable within the scope of this disclosure. The four connections for each phase are accessible so that different coil configurations can be enabled by the coil driver 200. For an electric machine with 8 coils per phase, those coils can be connected in parallel, series, or a combination of series and parallel coils.

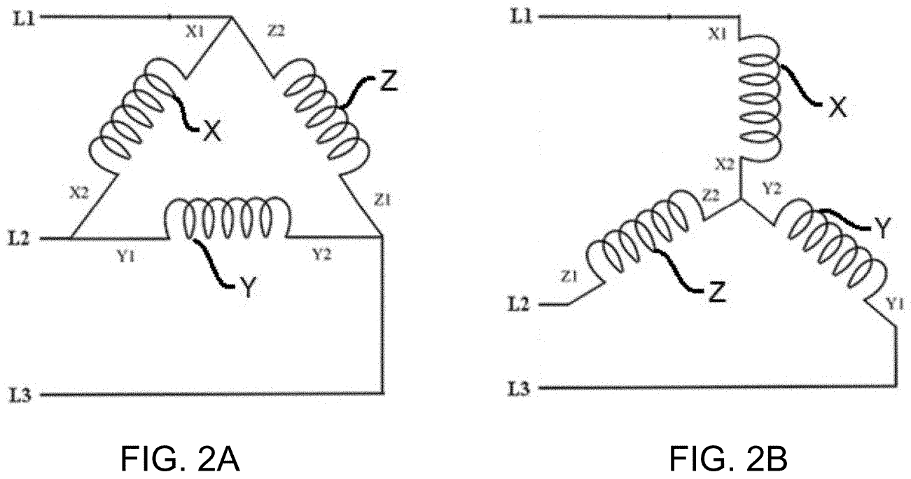

Further, a delta or wye configuration of the windings can be achieved by the coil driver 200. According to one aspect of the invention, the coil driver 200 can dynamically switch the coils between parallel and series configurations during machine operation. Likewise, the coil driver 200 can dynamically switch the coils between delta and wye configurations. FIG. 2A is a delta configuration and FIG. 2B is a wye or star configuration. As shown in FIG. 2A, a delta configuration is achieved by connecting end X1 of coil X to end Z2 of coil Z, end X2 of coil X to end Y1 of coil Y, and end Y2 of coil Y to end Z1 of coil Z. As shown in FIG. 2B, a wye or star configuration is achieved by creating a common node by connecting end X2 of coil X, end Z2 of coil Z, and end Y2 of coil Y. While the coils X, Y, Z for the three-phase machine are shown as 3 simple coils, this is a schematic representation as each coil can be made up of multiple series and/or parallel connected coils in the stator slots.

A number of separate paths through the stator winding are provided for each phase, also referred to as coils. These separate paths are also referred to a parallel paths. A maximum number of parallel paths is determined by a slot count of the electric machine, which is a number of stator slots, and the number of phases. In a three-phase machine each path goes through the stator twice, one into the stator and one out of the stator. The maximum number of parallel paths can be found with the following equation:

(Number of Slots)/(Number of Phases)/2=Maximum Number of Parallel Paths (eq. 1)

Therefore, for a 48 slot, three-phase machine the maximum number of parallel paths is 8 parallel paths.

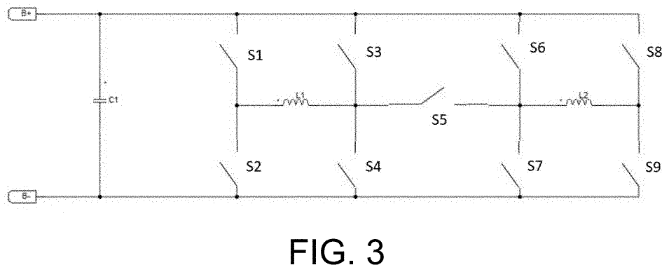

FIG. 3 is a single phase coil driver schematic. This schematic would be duplicated for each phase of a multi-phase electric machine. In FIG. 3 L1 and L2 represent electric machine coils for a single phase and C1 is a DC link energy storage element. Switches S1, S2, S3, S4, S6, S7, S8, and S9 function as PWM switches for the inverter and S5 is a series switch. Typically the switches would be comprised of one or more semiconductor devices, for example silicon or silicon carbide MOSFET, IGBT etc. A controller drives the switches. The controller can be a microcontroller or the like.

The coil driver depicted in FIG. 3 has two operating modes a series mode and a parallel mode. In the series mode, S5 is ON, S3, S4, S6, and S7 are “OFF” and S1, S2, S8, and S9 are in “PWM” mode forming an active “H bridge” driving the series connected coil. In series mode coil pairs from each phase are switched in series and driven by one H bridge per phase. In the parallel mode S5 is “OFF” and S1 to 4 and S6 to S9 are in “PWM” mode, which creates two H bridges driving L1 and L2 as individual coils. In parallel mode the coil pairs are individually driven by their own H bridge, resulting in 2 H bridges per phase.

The coil driver for each phase of a multi-phase electric machine shown in FIG. 3 includes a DC energy store C1 coupled between ports B+ and B− of the coil driver and four switch pairs and a series switch. A first switch pair has at least two switch elements S1, S2 connected in series between the ports of the coil drive and having a first node between the at least two switch elements S1, S2. A second switch pair having at least two switch elements S3, S4 connected in series between the ports of the coil drive and having a second node between the at least two switch elements S3, S4. A first AC drive current or AC voltage for a first coil L1 is generated between the first node and the second node. A third switch pair is connected in series between the ports of the coil drive and having a third node between the at least two switch elements S6, S7. A fourth switch pair having at least two switch elements S8, S9 connected in series between the ports of the coil drive and having a fourth node between the at least two switch elements. A second AC drive current or AC voltage for a second coil L2 is generated between the third node and the fourth node. A fifth switch S5 is connected in series between the second node and the third node.

There are two distinct operating modes that provide different opportunity for ripple current reduction. In a series mode coil pairs from each phase are switched in series and driven by one H bridge per phase. In a parallel mode the coil pairs are individually driven by their own H bridge, resulting in 2 H bridges per phase.

Each of the two operating modes are distinct and offer different opportunities for ripple current reduction.

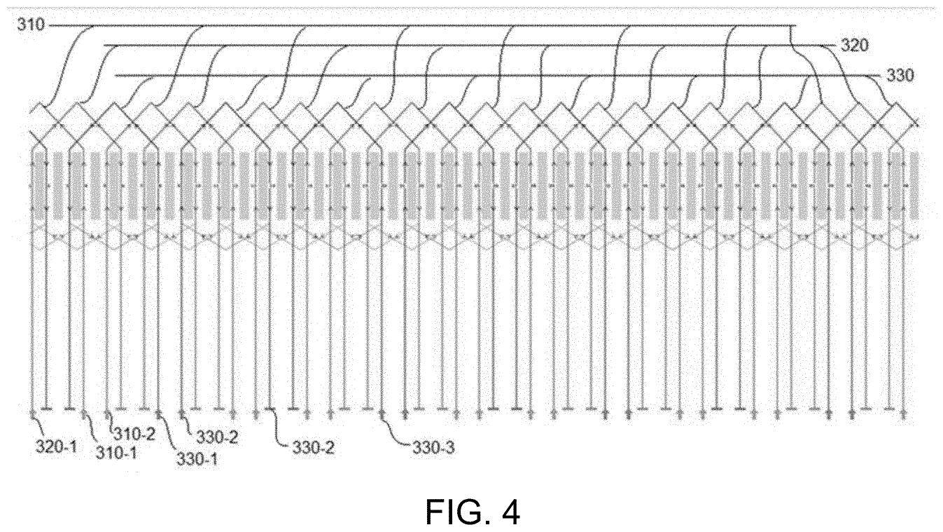

FIG. 4 is a schematic representation of a 48 slot, three-phase electric machine. The electric machine of FIG. 4 has eight parallel paths per phase. In this example, all 8 parallel paths are available. The individual coils are grouped into three phases 310, 320, 330. Each coil is individually accessible. For example, node 320-1 is an input for the coil in slots 1 and 6, node 310-1 is an input for the coil in slots 4 and 47, node 310-2 is an for the coil in slots 5 and 10, node 330-1 is an input for the coil in slots 8 and 3, and node 330-2 is an input for the coil in slots 9 and 14. The direction of current flow through each coil is designated by the arrow direction. The availability of each coil's connection nodes allows the coils to be connected in different configurations. For example, for a series connection, the node coil 330-2, which given the current flow in this example is an output node, can be connected to node 330-3, which given the current flow in this example is an input node. Alternatively, nodes 310-1 and 310-2 can be tied together placing the coils in parallel.

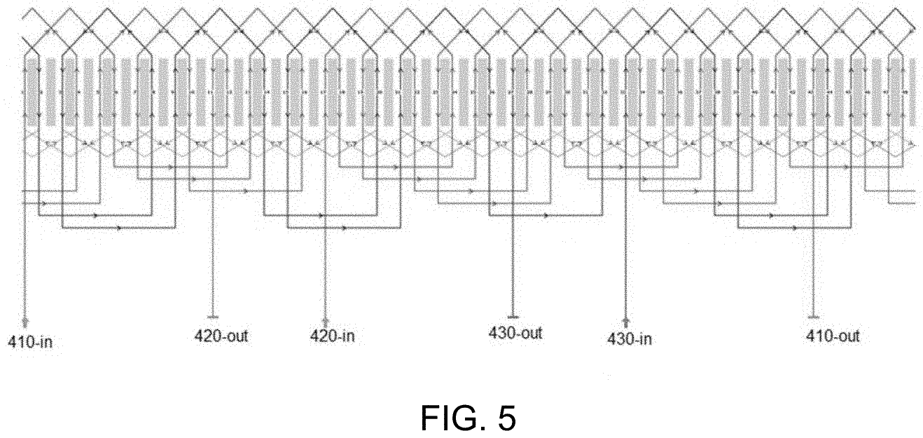

FIG. 5 is a schematic representation of a 48 slot, three-phase electric machine with all of the coils in a respective phase connected in series. There are three inputs and three outputs, one for each phase. The first phase has an input 410-in at slot 1 and an output 410-out at slot 43. The second phase has an input 420-in at slot 17 and an output 420-out at slot 11. The third phase has an input 430-in at slot 33 and an output 430-out at slot 27. Current flows in each phase in a direction of the arrows. It should be noted that the reference to input and output are based on current direction in the example so that if the current flows in the opposite directions the inputs would be the outputs. One path results in a single coil per phase. The single coil per phase configuration shown in FIG. 5 is typically not used with the coil driver shown in FIG. 3 because that coil driver uses two coils. However, the coil driver of FIG. 3 can create a parallel path condition from a two parallel path machine when in series mode.

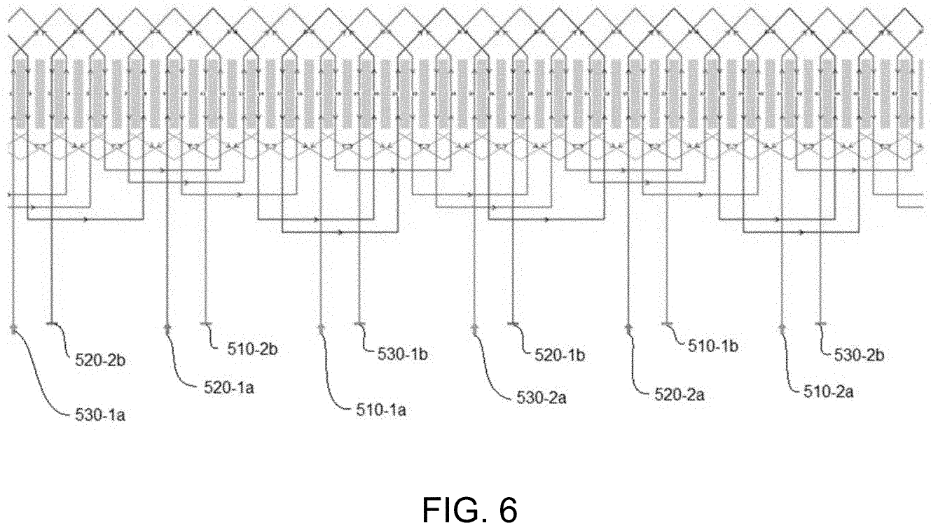

FIG. 6 is a schematic representation of a 48 slot, three-phase electric machine with the coils in a respective phase connected in two parallel paths. Two parallel paths results in a two coil per phase configuration. This configuration works well with the coil driver in FIG. 3 because one of the parallel paths corresponds with L1 in FIG. 3 and the other parallel path corresponds with L2 in FIG. 3. A first phase comprises two coils having inputs 510-1a and 510-2a and respective outputs 510-1b and 510-2b. A second phase comprises two coils having inputs 520-1a and 520-2a and respective outputs 520-1b and 520-2b. A third phase comprises two coils having inputs 530-1a and 530-2a and respective outputs 530-1b and 530-2b. As discussed above, the coils can be arranged in a delta or wye configuration.

According to one aspect of the invention, a group of individual coils when connected together for a given phase are referred to as a coil pack. For example, the first phase comprising the two coils having inputs 510-1a and 510-2a and respective outputs 510-1b and 510-2b would be a first and second coil pack A second phase comprising the two coils having inputs 520-1a and 520-2a and respective outputs 520-1b and 520-2b would be a third and fourth coil pack. A third phase comprising the two coils having inputs 530-1a and 530-2a and respective outputs 530-1b and 530-2b would be a fifth and sixth coil pack.

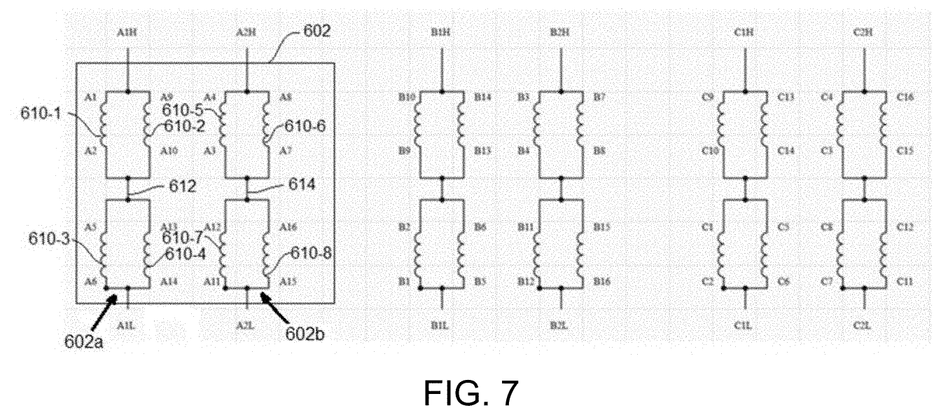

The 48 slot, three-phase electric machine having eight parallel paths per phase shown in FIG. 4 can be configured into the coil configuration of FIG. 7. The coils of each phase are combined to provide a desired voltage/current characteristic. The electric machine can be configured with two or four parallel paths, based at least in part on the number of driving connections of the coil driver.

As shown in FIG. 7, the coils are arranged with eight coils per phase. There are two parallel paths, each path comprising four coils. Each path comprises two pair of parallel coils that are arranged in series with one another. One phase winding 602 will be described in detail.

First phase winding 602 comprises 8 windings configured as two coil packs. A first coil pack 602a is connected between nodes A1H and A1L and a second coil pack 602b is connected between nodes A2H and A2L. The first coil pack comprises coils 610-1 and 610-2, connected in parallel between node A1H and node 612 and coils 610-3 and 610-4, connected in parallel between node 612 and node A1L. The two sets of parallel coils are in series with each other. A second coil pack 602b comprises coils 610-5 and 610-6, connected in parallel between node A2H and node 614 and coils 610-7 and 610-7, connected in parallel between node 614 and node A2L. The two sets of parallel coils are in series with each other. According to one aspect of the invention, each parallel coil pair can be a respective coil pack so that instead of two coil packs there are four coil packs.

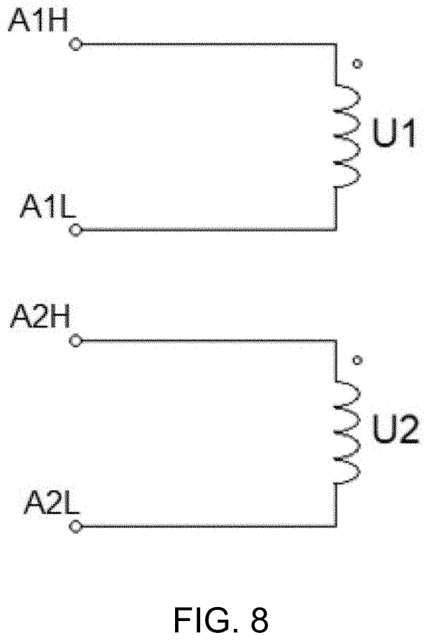

FIG. 8 is a schematic representation of the two coil packs 602a, 602b in first phase winding 602 in FIG. 7. The coil U1 corresponds to the first coil pack 602a comprising coils 610-1, 610-2, 610-3, and 610-4. The coil U2 corresponds to the second coil pack 602b comprising coils 610-5, 610-5, 610-7, and 610-8. Relating the schematic representation of FIG. 8 to FIG. 1, U1 corresponds to coil 10a and U2 corresponds to coil 10b.

In the above description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

The various embodiments described above can be combined to provide further embodiments. Aspects of the embodiments can be modified, if necessary, to employ systems, circuits and concepts of the various patents, applications and publications identified herein to provide yet further embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation”, “one aspect”, or “an implementation” means that a particular feature, structure or characteristic described in connection with the implementation is included in at least one implementation. Thus, the appearances of the phrases “in one implementation”, “in an implementation”, or “in one aspect” in various places throughout this specification are not necessarily all referring to the same implementation. Furthermore, the particular features, structures, or characteristics may be combined in any suitable manner in one or more implementations.

The headings and abstract provided herein are for convenience only and do not interpret the scope or meaning of the implementations.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method acts that perform substantially the same function in substantially the same way to achieve the same results are within the scope of the invention. Moreover, it should be recognized that structures and/or elements and/or method acts shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An N-phase electric machine comprising:
a stator having a plurality of stator slots;
a rotor mounted to rotate with respect to the stator; and
a plurality of coils each having a first connection node and a second connection node, wherein there is a respective coil for each of the plurality of stator slots;
wherein the plurality of coils are electrically connected as coil packs;
wherein for the N-phase electric machine there are 2N coil packs; and
wherein the first connection node and the second connection node for each coil are accessible to implement a plurality of electric machine configurations.

2. The N-phase electric machine of claim 1, wherein the 2N coil packs for every N phases are electrically isolated from each other.

3. The N-phase electric machine of claim 1, wherein the plurality of electric machine configurations comprises at least one of a delta configuration and a wye configuration.

4. The N-phase electric machine of claim 1, wherein each coil pack comprises at least one of electrically coupled series coils and parallel coils.

5. The N-phase electric machine of claim 1, further comprising:
a connector block comprising a connection node for each first connection node and each second connection node of each coil.

6. The N-phase electric machine of claim 5, wherein the connector block is accessible from an outside of the N-phase electric machine.

7. The N-phase electric machine of claim 1, wherein a maximum number of parallel paths is equal to one half a number of slots divided by a number of phases N.

8. A system comprising:
an N-phase electric machine comprising:
a stator having a plurality of stator slots;
a rotor mounted to rotate with respect to the stator; and
a plurality of coils each having a first connection node and a second connection node, wherein there is a respective coil for each of the plurality of stator slots, wherein the first connection node and the second connection node for each coil are accessible to implement a plurality of electric machine configurations;
wherein the plurality of coils are electrically connected as coil packs;
wherein for the N-phase electric machine there are 2N coil packs; and
a connection block comprising a connection node for each first connection node and each second connection node of each coil; and
a coil driver that provides a driving current to each coil via the connection block and connects the respective coils in each coil pack to implement each of the plurality of electric machine configurations.

9. The system of claim 8, wherein the plurality of electric machine configurations comprises at least one of a delta configuration and a wye configuration.

10. The system of claim 8, wherein each coil pack configuration comprises at least one of electrically coupled series coils and parallel coils.

11. The system of claim 8, wherein the connection block is accessible from an outside of the N-phase electric machine.
